(19) United States
(12) Patent Application Publication
(10) Pub. No.: US 2007/0178419 A1
(43) Pub. Date: Aug. 2, 2007

(54) Apparatus for cleaning orthodontic and dental appliances

(76) Inventors: Richard H. Berman, Devon, PA (US); Mindyjane Berman, Devon, PA (US)

Correspondence Address: Gary M Cohen, Strafford Building Number Three, 125 Strafford Avenue Suite 300, Wayne, PA, 19087-3318, US

(21) Appl. No.: 11/587,264

(22) PCT Filed: Apr. 26, 2005
(86) PCT No.: PCT/US05/14286

§ 371 Date: Oct. 23, 2006

Related U.S. Application Data
(60) Provisional application No. 60/567,139, filed on Apr. 30, 2004.

(51) Int. Cl. A61C 3/00

(52) U.S. Cl. 433/3

(57) ABSTRACT

A hand-held cleaning device includes an elongated handle having an operative end. The operative end includes a flattened, relatively small hook, and a flexible neck. A cover can be provided to protect the operative end of the cleaning device. To use the cleaning device, for example, to clean between the palate of the wearer of a palatal expander appliance and portions of the palatal expander appliance, the hook end is slid between the palate of the wearer and the palatal expander appliance, either by the wearer of the appliance or by another person, and any food or other debris trapped in the space between the appliance and the palate of the wearer can be swept aside, pushed forward or engaged with the hook and pulled from between the palate and the appliance.

### BACKGROUND OF THE INVENTION

The present invention relates generally to a method and a device for debriding orthodontic and dental appliances, and more particularly, to a hand-held tool and associated technique employed by a wearer of the appliances or an assistant for cleaning such appliances and the spaces developed between such appliances and the adjacent living tissue of the wearer.

The cleaning device and the associated method of the present invention can be used to remove trapped debris from any orthodontic or dental appliance having areas where food can become trapped, or from between such appliances and adjacent living connective tissue. While this can include any of a variety of appliances, including but not limited to Hyrax, Haas, Herbst, MARA, NANCE and pendulum type appliances, the description which follows is presented in the context of a class of appliances generally known as a palatal expander.

A palatal expander is a well known appliance whose function is to gradually spread the maxillary arch and thereby provide greater space for proper alignment of the upper teeth. Typically, such an appliance is formed with a segmented body disposed in the palatal cavity, a pair of stainless steel wires extending laterally from opposite sides of the body, and a tooth-engaging band or acrylic pad secured at the free end of each wire. The bands or pads are secured, for instance, to the first molars and first bicuspids. When the segmented body is placed into the palatal cavity, a minimal space is created between structures associated with the palatal expander, in particular, the segmented body, and the surface of the palate, creating locations for food impaction.

U.S. Pat. No. 3,977,082 (Siatkowski) discloses a palatal expander having a segmented body which is placed closely into the palatal vault. As a result of this placement, a toothbrush, toothpick, or other available dental cleaning device cannot sufficiently gain access to the space between the palatal expander and the palate to remove food particles which impact upon eating. Toothbrushes are too thick to gain access to this space. Toothpicks are both too thick and too rigid to gain access to this space. Proxabrushes are too short to gain access to this space, and would bend out of shape if used.

Thus, the problem remained to devise a tool that would easily and safely allow the wearer or an assistant to remove impacted food from between the palatal expander and the palatal vault.

### SUMMARY OF THE INVENTION

In accordance with the present invention, a tool is provided for cleaning orthodontic and dental appliances having areas where food can become trapped, or from between such appliances and the adjacent living connective tissue of a wearer, such as the space between the segmented body of a palatal expander and the palatal vault of the wearer. The tool is preferably implemented as a hand-held cleaning device which generally includes an elongated handle having an operative end. The operative end of the cleaning device includes a flattened, relatively small hook and a flexible neck. A cover can also be provided to protect the operative (cleaning) end of the device.

In use, for example, to clean the space between the segmented body of a palatal expander and the palatal vault of the wearer, the handle of the cleaning device is grasped by a user, and the hook associated with the operative end of the device is slid between the palate of the wearer and the palatal expander appliance, either by the wearer of the appliance or by another person. Any food or debris trapped in this space can in this way be swept aside, pushed forward or engaged with the hook and pulled from between the appliance and the palate of the wearer.

### BRIEF DESCRIPTION OF THE DRAWINGS

FIG. 1 is a plan view of a first alternative embodiment of the cleaning tool of the present invention.

FIG. 2 is a side, elevational view of the cleaning tool shown in FIG. 1.

FIG. 3 is a plan view of a second alternative embodiment of the cleaning tool of the present invention, which further includes a contoured handle.

FIG. 4 is a side, elevational view of the cleaning tool shown in FIG. 3.

FIGS. 5A and 5B are plan views of the cleaning tool of the present invention, showing alternative hook configurations and handle shapes.

FIG. 6 is a cap for covering the operative end of the cleaning tool of the present invention.

FIGS. 7A, 7B and 7C show further alternative embodiments of the cleaning tool of the present invention, having operative blades which fold and which are stored inside a handle.

FIG. 8 is a side, elevational view of the cleaning tool shown in FIG. 7C.

### DETAILED DESCRIPTION OF PREFERRED EMBODIMENTS

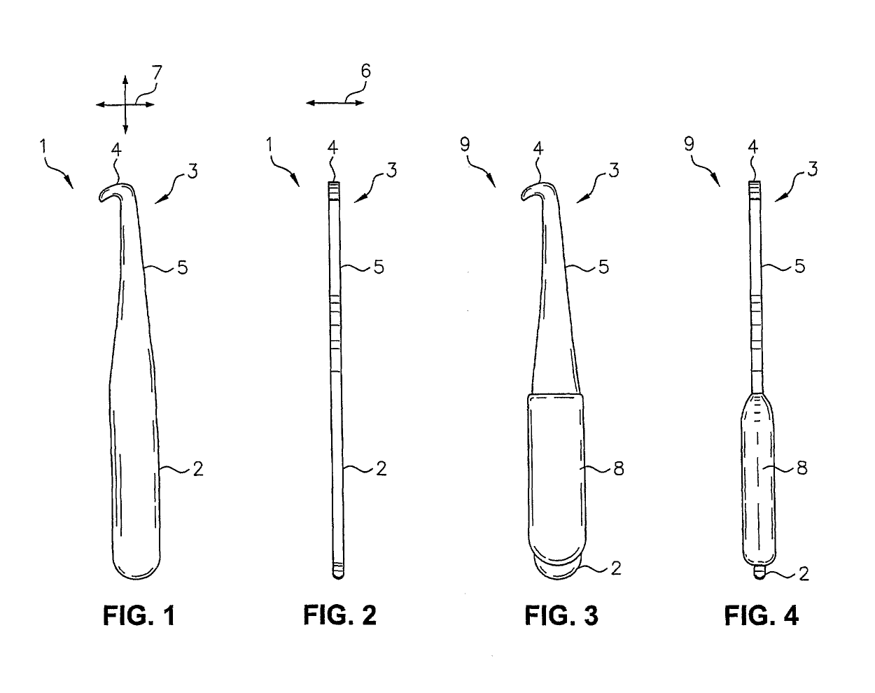

FIGS. 1 and 2 show a first alternative embodiment cleaning device 1 which is produced in accordance with the present invention. The cleaning device 1 can be used to remove trapped debris from any of a variety of orthodontic and dental appliances having regions where food can become trapped, or from between such appliances and adjacent living connective tissue. This can include any of a variety of conventional appliances including, but not limited to, Hyrax, Haas, Herbst, MARA, NANCE and pendulum type appliances. For purposes of convenience only, the description which follows is presented in the context of a class of appliance which is generally known as a palatal expander, for cleaning a space developed between the palatal expander, in particular the segmented body of the palatal expander, and the palatal vault of the wearer.

In its simplest form, the cleaning device 1 can be implemented as a hand-held tool which generally includes an elongated handle 2 having an operative end 3. The operative end 3 of the cleaning device 1 includes a flattened, relatively small hook 4 and a flexible neck 5.

The cleaning device 1 is unitary in construction, and can be stamped from any of a variety of sheet materials or injection molded using any of a variety of plastics. The use of flexible synthetic resin materials is presently considered preferred. However, other flexible materials, including plastics, rubbers and metals, could also be used, if desired. The material can have a thickness on the order of from 0.1 mm to 2.0 mm, with a thickness of 0.5 mm±0.2 mm being preferred. The selected thickness for the material which is used to develop the cleaning device of the present invention should allow the neck portion 5 to bend laterally, in the direction shown by the arrow 6 in FIG. 2, along curved portions of the palate. The selected thickness for the material which is used to develop the cleaning device should also be sufficiently rigid so that when the neck portion 5 is moved either laterally or longitudinally, in the directions shown by the arrows 7 shown in FIG. 1, the operative end 3 can push debris from the space between a palatal expander appliance and the palate of the wearer of the appliance.

The cleaning device of the present invention can be provided with various convenience features, and can have any of a variety of different configurations for facilitating use of the cleaning device, if desired.

For example, and referring to FIGS. 3 and 4, a grip 8 can be added to the handle 2 of the cleaning device 1 shown in FIGS. 1 and 2 to provide a cleaning device 9 having improved maneuverability. The grip 8 can be formed as a unitary structure for encasing the handle 2, or can be implemented as opposing sections for surrounding the handle 2. The handle 2 and the grip 8 can also be formed as a unitary structure, if desired.

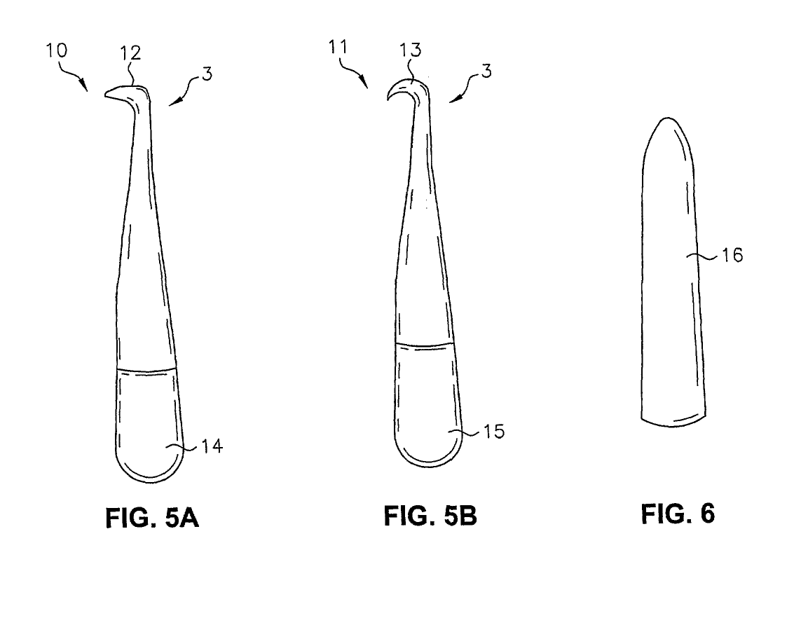

In FIGS. 5A and 5B, the cleaning devices 10, 11 have hooks 12, 13, respectively, with different curvatures and overall shapes. The cleaning devices 10, 11 also have different handles 14, 15 joined to the operative ends 3 of the respective cleaning devices 10, 11. In these configurations, the handles 14, 15 are broadened for facilitating grasping of the cleaning device by a user.

FIG. 6 illustrates a cap 16 which can be used to overfit the operative ends 3 of the various cleaning devices 1, 9, 10, 11, to protect the operative end 3 from contaminants during storage.

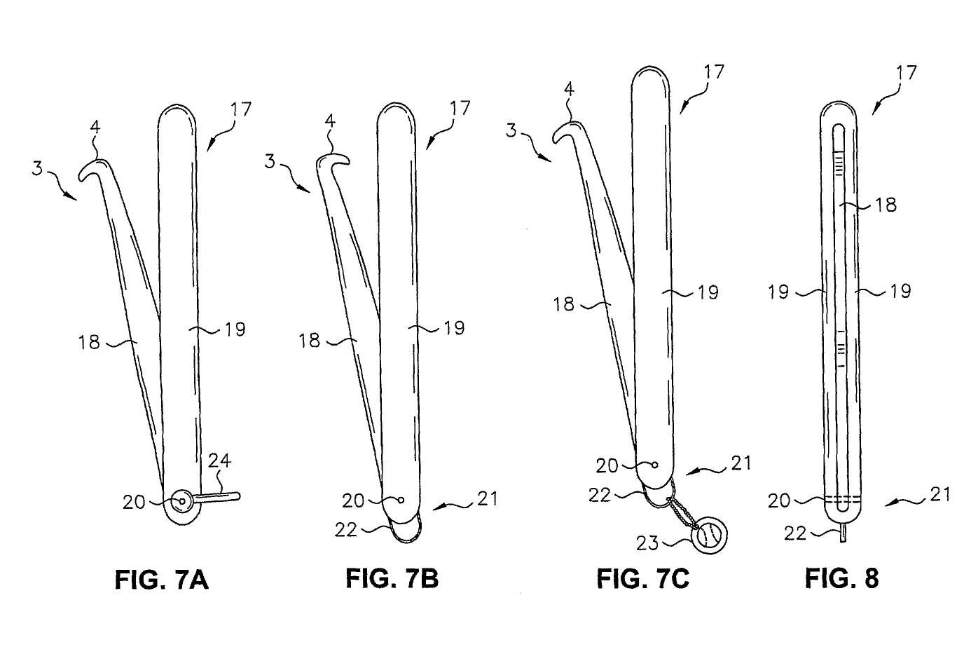

As an alternative to the cap 16 shown in FIG. 6, a cleaning device 17 is provided which includes a blade 18 having a configuration similar to the cleaning device 1 shown in FIG. 1 which is mounted within a handle 19, as is shown in FIGS. 7A, 7B, 7C and 8. In this configuration, the blade 18 can be pivoted about a mounting pin 20, allowing the blade 18 to be withdrawn from the handle 19 for desired use, and can be returned to the enclosure of the handle 19, to again protect the operative end 3 from contaminants during storage. As alternatives, the hook 4 of the blade 18 can face outwardly, as is shown in FIG. 7A, or inwardly, as is shown in FIG. 7B.

If desired, an end 21 of the handle 19 can be provided with a ring 22, which can be used for purposes of hanging the cleaning device from a desired structure, or for hanging an article 23 from the ring 22, for example, for purposes of advertising, as is shown in FIG. 7C.

The end 21, or the opposing end of the handle 19 can also be provided with a key 24 for use in adjusting the palatal expander as is disclosed, for example, in U.S. Pat. No. 5,133,659 (Shilliday). For convenience of operation, the key 24 is preferably coupled with the end 21 of the handle 19, for rotation about the mounting pin 20 which operates to allow the blade 18 to be withdrawn from the handle 19. The key 24 can then be conveniently deployed for use in advancing an orthodontic screw in the palatal expander, or some other orthodontic appliance. Once deployed, the key 24 is conveniently inserted into the intra-oral expander screw of the palatal expander, for use in advancing the screw by grasping the handle of the device. The key 24 can have features for limiting the amount of advancement, if desired, or other features which enable safe, effective rotation of the expanding element.

In use, and irrespective of the specific configuration selected for the cleaning device, the handle of the cleaning device is grasped by a user, and the hook associated with the operative end of the cleaning device is slid between the palate of the wearer and the palatal expander appliance, either by the wearer of the appliance or by another person. Any food or debris trapped in this space can in this way be swept aside, pushed forward or engaged with the hook and pulled from between the appliance and the palate of the wearer.

It is to be understood that various changes in the details, materials and arrangement of parts which have been herein described and illustrated in order to explain the nature of this invention may be made by those skilled in the art.

For example, other embodiments of the present invention can include a cleaning device having a handle which is equipped with a cover to protect the opposing end of the device, or a handle which has an opening to accept an attachment for purposes of identification or other marketing purposes, or to receive the key 24.

Also, as previously mentioned, the cleaning device 1 can be used to remove trapped debris from any of a variety of orthodontic and dental appliances having regions where food can become trapped, or from between such appliances and adjacent living connective tissue, in addition to the previously described palatal expander.

Accordingly, while the foregoing embodiments of the present invention have been illustrated and described in detail, the foregoing description is not intended to limit the scope of the invention as expressed in the following claims.

What is claimed is:

1. A hand-operated tool for debriding orthodontic and dental appliances, and spaces between the orthodontic and dental appliances and adjacent living connective tissue, comprising:
an elongated handle having an operative end and defining a longitudinal axis, wherein the operative end of the elongated handle includes a flattened hook portion and a flexible neck portion, and wherein the neck portion is formed of a flexible material and has a thickness which allows the neck portion to bend laterally, along the longitudinal axis of the handle, and which is sufficiently rigid, when the hook portion is moved laterally and longitudinally, to move debris and perform the debriding.

2. The tool of claim 1 wherein the elongated handle, including the flattened hook portion and the flexible neck portion, are unitary in construction.

3. The tool of claim 1 wherein the flexible neck portion is formed of a flexible material selected from the group of materials consisting essentially of synthetic resins, plastics, rubbers and metals.

4. The tool of claim 1 wherein the flexible neck portion has a thickness of from 0.1 mm to 2.0 mm.

5. The tool of claim 4 wherein the flexible neck portion has a thickness of 0.5 mm±0.2 mm.

6. The tool of claim 1 which further includes a grip associated with an end of the elongated handle opposite to the operative end.

7. The tool of claim 6 wherein the grip and the elongated handle are unitary in construction.

8. The tool of claim 1 which further includes a cap for overfitting the operative end of the elongated handle.

9. The tool of claim 1 wherein the elongated handle is pivotally mounted in a handle for enclosing the elongated handle.

10. The tool of claim 9 which further includes a pin coupled with an end of the elongated handle opposite to the operative end, for receiving the elongated handle for rotation relative to the handle for enclosing the elongated handle.

11. The tool of claim 10 wherein, in a first mode, the elongated handle is withdrawn from the handle for enclosing the elongated handle, and in a second mode, the elongated handle is located within the handle for enclosing the elongated handle to protect the operative end from contaminants during storage.

12. The tool of claim 1 wherein an end of the elongated handle opposite to the operative end includes a ring for engaging desired components.

13. The tool of claim 1 which further includes a key for adjusting a palatal expander.

14. The tool of claim 13 wherein the key is pivotally coupled with portions of the tool, for desired withdrawal from the tool.

15. The tool of claim 14 which further includes an opening for receiving the key.

16. A method for operating the hand-operated tool of claim 1, comprising the steps of:
grasping the tool, and moving the elongated handle in lateral and longitudinal directions so that the neck portion of the elongated handle bends laterally, along the longitudinal axis of the handle, and so that lateral and longitudinal movements of the hook portion moves debris and performs debriding.

17. The method of claim 16 which further includes the step of engaging the debris with the hook portion, and withdrawing the debris using the hook portion.

18. The method of claim 16 which further includes the step of sliding the hook portion between a palate of a wearer and a palatal expander appliance worn by the wearer, and sweeping trapped food and debris from between the palatal expander appliance and the palate of the wearer.
